(19) United States
(12) Patent Application Publication
(10) Pub. No.: US 2009/0088064 A1
(43) Pub. Date: Apr. 2, 2009

(54) Motor vehicle air cooling method and system

(75) Inventor: Chien-Erh Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: Chien-Erh Lin, Taipei City (TW)

(21) Appl. No.: 11/905,204

(22) Filed: Sep. 28, 2007

(51) Int. Cl. B60H 1/00

(52) U.S. Cl. 454/75; 165/41; 454/141; 454/156; 454/164

(57) ABSTRACT

A motor vehicle air cooling method and system in which electric fans are installed in the rear side of a motor vehicle to draw hot air out of the inside space of the motor vehicle so as to cause negative pressure in the motor vehicle for sucking outside cooling air into the inside of the motor vehicle to have the pressure inside the motor vehicle be in balance with the pressure outside the motor vehicle and to simultaneously lower the temperature in the motor vehicle after an air conditioner ventilation panel of the motor vehicle has been set in an outer loop status.

### BACKGROUND OF THE INVENTION

1. Field of the Invention

The present invention relates to a motor vehicle air cooling measures and more particularly, to a motor vehicle air cooling method and system in which electric fans are installed in the rear side of the motor vehicle to draw air out of the motor vehicle and to cause negative pressure in the motor vehicle for sucking outside cooling air into the inside of the motor vehicle to have the pressure inside the motor vehicle be in balance with the pressure outside the motor vehicle and to simultaneously lower the temperature in the motor vehicle after the air conditioner ventilation panel of the motor vehicle has been set in an outer loop status.

2. Description of the Related Art

Following change in living conditions and popularization of cars, many people use a car as one's personal transportation vehicle. However, when a car is parked in an outdoor parking lot and exposed to the radiation of the light of the sun, the temperature of the enclosed inside space of the car rises soon. When a car is exposed to the radiation of the light of the sun for one hour, the temperature of the front windshield glass and the rear windshield glass could be as high as 80° C., the temperature of the front bumper and the rear bumper could be as high as 72˜75° C., and the temperature beneath the seats inside the car could be as high as 60° C. If the inside temperature of a car is excessively high due to the radiation of the light of the sun, the driver or passenger may have to open the windows of the car for circulation of air through the car for a certain period of time before entering the car.

Further, when the inside temperature of a car is excessively high, the inflammable articles (disposable cigarette lighter, rosin oil, etc.) carried in a car may explode to damage the stereo system, dashboard or seat coverings. If beverage bottles or cans are carried in a car, the beverage bottles or cans deteriorate soon when the inside temperature of the car is excessively high. It is harmful to the health to drink deteriorated beverage. Further, a high temperature may cause the plastic or chemical materials of the car to release volatized organic substances (such as toluene, ethylbenzene, decyl aldehyde, dodecane) and formaldenyde. Breathing in a certain concentration of these substances will cause damage to the human body. Further, exposing a car to a high temperature environment for long will shorten the service life of the internal devices or parts of the car.

Further, when the temperature inside a car is much higher than the temperature outside the car, it gives a burden to the air conditioner of the car, and it takes much time to lower the inside temperature of the car. Operating the air conditioner of a car under this condition will increase fuel consumption of the car and shorten the service life of the air conditioner. Keeping the car windows partially opened during parking of a car allows circulation of air through the car and can lower the inside temperature of the car. However, the car may be stolen easily or rainwater may fall to the inside of the car if the car windows are not tightly closed.

Many measures have been disclosed to eliminate the aforesaid problems. FIG. 9 illustrates a solar panel 11 installed in a sky window A1 of a car A and electrically connected to the air blower A2 in the engine of the car A to provide electric power to the air blower A2. FIG. 10 illustrates a solar panel A11 installed in a sky window A1 of a car A and electrically connected to an air ventilator A3 in each of the two opposite front door windows to provide electric power to the air ventilators A3. Each air ventilator A3 has a suction port A31 through which outside cooling air is sucked into the inside of the car A. When the air blower A2 or the air ventilator A3 is started, outside cooling air is drawn into the inside of the car A to cause positive pressure in the inside space of the car A, and therefore the relatively higher pressure of car inside air flows toward the relatively lower pressure space outside the car subject to Le Chatelier's principle, to have the inside air pressure of the car be in balance with the pressure outside the car and to simultaneously lower the inside temperature of the car.

However, when outside cooling air is drawn into the inside of the car A during the operation of the air blower A2 or the air ventilator A3, the intake outside cooling air is mixed with the inside hot air of the car A to lower the temperature of the inside space of the car A. Therefore, when air is expelled out of the inside space of the car A, the exhaust current of air carries less amount of heat energy, resulting in low cooling efficiency. Further, because the car inside space is much smaller than the car outside space, the positive pressure of the inside space of the car A is soon expelled to the outside of the car A to reach a balanced status, lowering the dissipation of heat from the inside space of the car A. Therefore, the aforesaid two solar energy-operated prior art designs have low efficiency in cooling the car A.

In general, the aforesaid two prior art designs have the following drawbacks:

1. When outside cooling air is drawn into the inside of the car A during the operation of the air blower A2 or the air ventilator A3, the intake outside cooling air is mixed with the inside hot air of the car A to lower the temperature of the inside space of the car A. Therefore, when air is expelled out of the inside space of the car A, the exhaust current of air carries less amount of heat energy, resulting in low cooling efficiency.

2. The air blower A2 or air ventilator A3 obtains the necessary working voltage from the solar panel A11. Because the solar panel A11 is expensive, the cost of the aforesaid two prior art designs is high.

3. It is complicated to install the solar panel A11 in the sky window A1 and to electrically connect the solar panel A11 to the blower A2 in the car engine.

Therefore, it is desirable to provide a motor vehicle air cooling method and system that eliminates the aforesaid drawbacks.

### SUMMARY OF THE INVENTION

The present invention has been accomplished under the circumstances in view. According to one aspect of the present invention, the motor vehicle air cooling method is to install a motor vehicle air cooling system in a motor vehicle having an air conditioner ventilation panel set in an outer loop position for letting outside air to flow into the inside of the motor vehicle. The motor vehicle air cooling system comprises at least one ventilation panel installed in the rear side of the motor vehicle, and at least one electric fan respectively installed in the at least one ventilation panel and adapted to draw air out of the motor vehicle through the at least one ventilation panel and to cause negative pressure in the motor vehicle, and at least one sensor switch installed in the at least one electric fan and adapted to detect temperature around the at least one electric fan and to switch on the at least one electric fan when the detected temperature surpasses a predetermined value. After a negative pressure is caused in the motor vehicle inside space of the motor vehicle, outside cooling air is guided into the motor vehicle inside space through the air conditioner ventilation panel of the motor vehicle for mixing with the hot inside air of the motor vehicle, and then the electric fans are operated to draw air out of the motor vehicle, lowering the temperature of the motor vehicle inside space efficiently.

According to another aspect of the present invention, the motor vehicle air cooling system further comprises at least one air duct extending from the motor vehicle inside space to the ventilation panels, and at least one second electric fan adapted to draw air from the motor vehicle inside space into the air duct toward the ventilation panels.

According to another aspect of the present invention, a storage battery is installed in the trunk or the motor vehicle inside space behind the rear seat of the motor vehicle and electrically connected to each electric fan to provide each electric fan with the necessary working voltage.

According to still another aspect of the present invention, the storage battery is electrically connected to a cigarette lighter socket of an electric power circuit of the motor vehicle. When the motor vehicle engine of the motor vehicle is started, a part of electric power of the electric power circuit is transmitted to the cigarette lighter socket to charge the storage battery.

According to still another aspect of the present invention, sensor switches are installed in each electric fan and adapted to detect the ambient temperature. When the ambient temperature reaches a predetermined value, each sensor switch switches on the associating electric fan for three minutes and then switches off the associating electric fan for seven minutes, and then starts to detect the ambient temperature again. This operation cycle does not require continuous operation of each electric fan, and therefore it saves much power consumption.

### BRIEF DESCRIPTION OF THE DRAWINGS

FIG. 1 is a perspective view showing a motor vehicle cooling system installed in a motor vehicle according to the present invention.

FIG. 2 is an exploded view of a part of the motor vehicle cooling system according to the present invention.

FIG. 3 is a schematic sectional side view of FIG. 1

FIG. 4 is a schematic sectional rear view of FIG. 1.

FIG. 5 is a schematic sectional side view showing circulation of air through the air conditioner of the motor vehicle ventilation panel and the air cooling system.

FIG. 6 is a perspective view of an alternate form of the motor vehicle cooling system installed in a van according to the present invention.

FIG. 7 is an operation flow of the present invention.

FIG. 8 is a circuit block diagram of the present invention.

FIG. 9 is a schematic drawing showing a solar energy-operated motor vehicle cooling design according to the prior art.

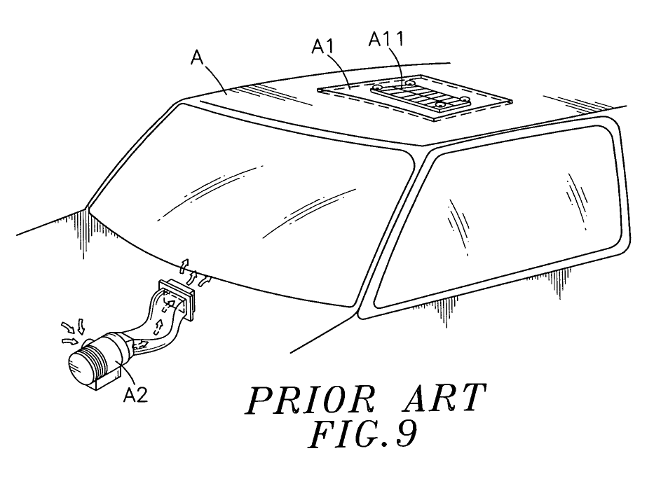

FIG. 10 is a schematic drawing showing another prior art solar energy-operated motor vehicle cooling design.

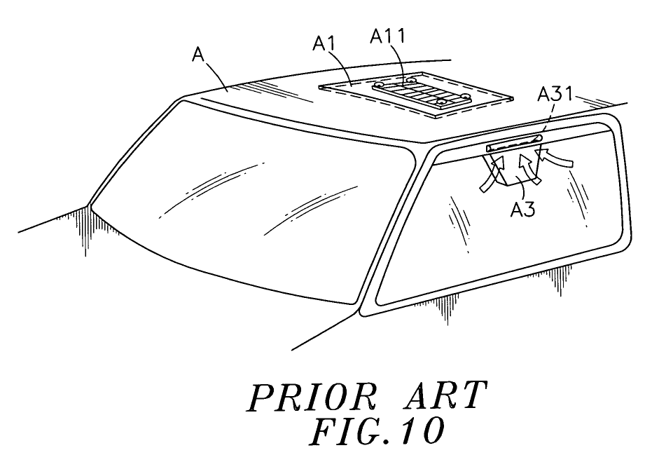

### DETAILED DESCRIPTION OF THE PREFERRED EMBODIMENT

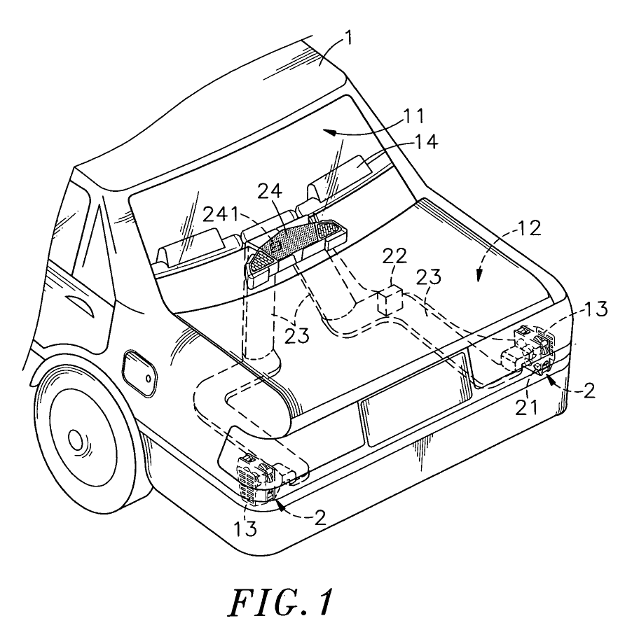

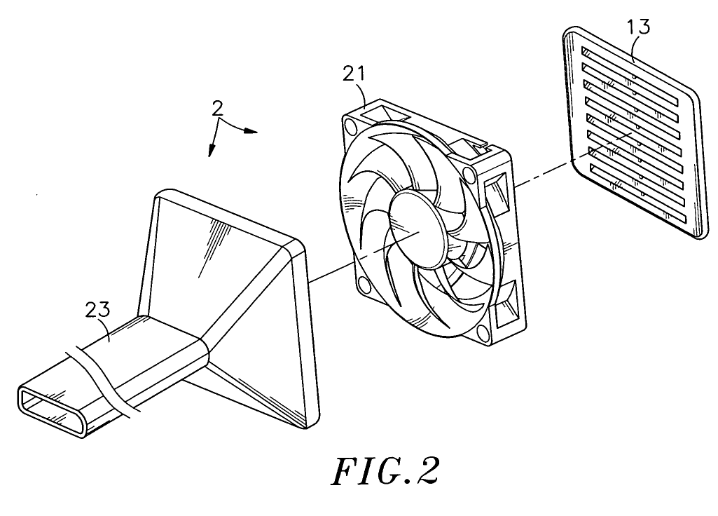

Referring to FIGS. 1 and 2, a motor vehicle air cooling method in accordance with the present invention is installed to a motor vehicle cooling system 2 in a motor vehicle 1.

At least one, for example, two ventilation panels 13 are mounted inside a trunk 12 of the motor vehicle 1 near the rear bumper. When the internal air pressure of the motor vehicle 1 surpasses the atmosphere, the internal air pressure forces the plastics (or rubber) louvers of the ventilation panels 13 to bias from the close position to the open position, and therefore the internal air pressure is released. The motor vehicle cooling system 2 according to the present preferred embodiment comprises two first electric fans 21 respectively installed in the ventilation panels 13. Each first electric fan 21 has a suction side facing the inside of the trunk 12, and an exhaust side facing the associating ventilation panel 13. Therefore, the first electric fans 21 suck air from the trunk 12, and exhaust air toward the ventilation panels 13. Further, the first electric fans 21 can be fastened to the respective ventilation panels 13 by means of screws, hooks, adhesive or nay of a variety of conventional bonding techniques.

However, a rear seat 14 of the motor vehicle 1 block ventilation between a motor vehicle inside space 11 inside the motor vehicle 1 and the space within the trunk 12. Therefore, the invention has two air ducts 23 mounted in the trunk 12 and kept under the floor carpet inside the trunk 12 from sight, each having one end respectively connected to the suction sides of the first electric fans 21 and the other end extending to gaps in between the rear set 14 and the frame structure of the motor vehicle 1 to guide air from the motor vehicle inside space 11. The air ducts 23 can be respectively formed of one single flexible tube. Alternatively, each air duct 23 can be formed of a plurality of tubes connected in series. The air ducts 23 can be made having a circular and flat cross section.

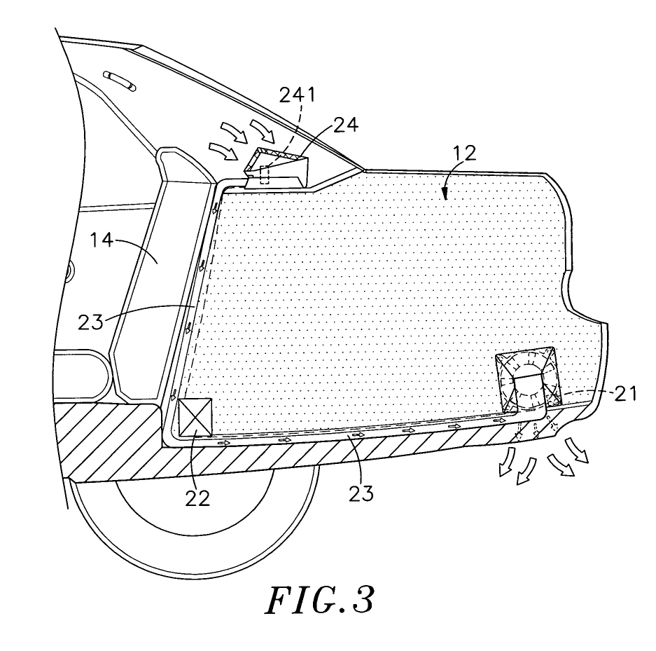

Referring to FIGS. 3˜5, when the first electric fans 21 of the motor vehicle cooling system 2 are started, the hot air is sucked from the motor vehicle inside space 11 into the air ducts 23 and then expelled out of the motor vehicle 1 through the ventilation panels 13. At this time, the internal air pressure of the motor vehicle 1 is smaller than the atmosphere, producing negative pressure. The air conditioner of the motor vehicle 1 is set in the outer loop status so that the air conditioner of the motor vehicle 1 sucks in outside cooling air into the motor vehicle inside space 11 through air conditioner ventilation panels 15 to keep the inside pressure of the motor vehicle 1 and the outside pressure in balance subject to Le Chatelier's Principle.

During operation of the of the motor vehicle cooling system 2, the first electric fans 21 draw hot air from the motor vehicle inside space 11 to the outside of the motor vehicle 1 through the ventilation panels 13, thereby carrying heat energy away from the motor vehicle inside space 11 of the motor vehicle 1, and at the same time, outside cooling air is sucked into the motor vehicle inside space 11 through the air conditioner ventilation panels 15 to lower the temperature of the motor vehicle inside space 11. Therefore, outside cooling air is continuously sucked into the motor vehicle inside space 11 and hot air is continuously drawn out of the motor vehicle inside space 11 to the outside of the motor vehicle 1 to lower the temperature of the motor vehicle inside space 11 during the operation of the motor vehicle cooling system 2.

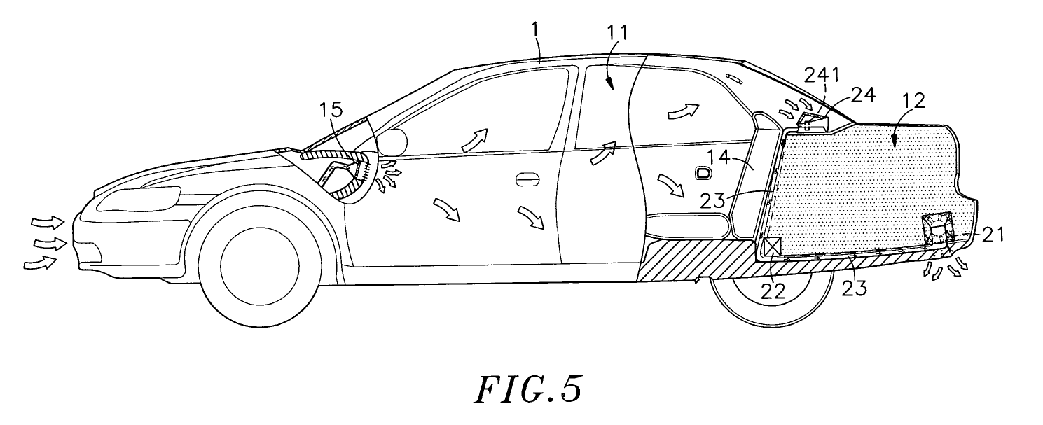

Referring to FIGS. 1, 3, 4 and 5 again, the air ducts 23 are installed in the trunk 12 and extended to the motor vehicle inside space 11, and the first electric fans 21 are operated to suck air from the motor vehicle inside space 11 into the air ducts 23 toward the ventilation panels 13. Because the air ducts 23 have a certain length, the capacity of first electric fans 21 is insufficient to draw hot air out of the motor vehicle inside space 11 as desired. Therefore, at least one second electric fan 24 is disposed inside the motor vehicle inside space 11 of the motor vehicle 1 behind the rear seat 14 without interfering with a driver's line of sight. During operation of the present invention, the second electric fan 24 sucks hot air from the motor vehicle inside space 11 into the air ducts 23, and the first electric fans 21 suck air from the air ducts 23 for expelling to the outside of the motor vehicle 1 through the ventilation panels 13. Further, a storage battery 22 is installed in the trunk 12 and electrically connected to the first electric fans 21 and the second electric fan 24 to provide the necessary working voltage to the electric fans 21 and 24.

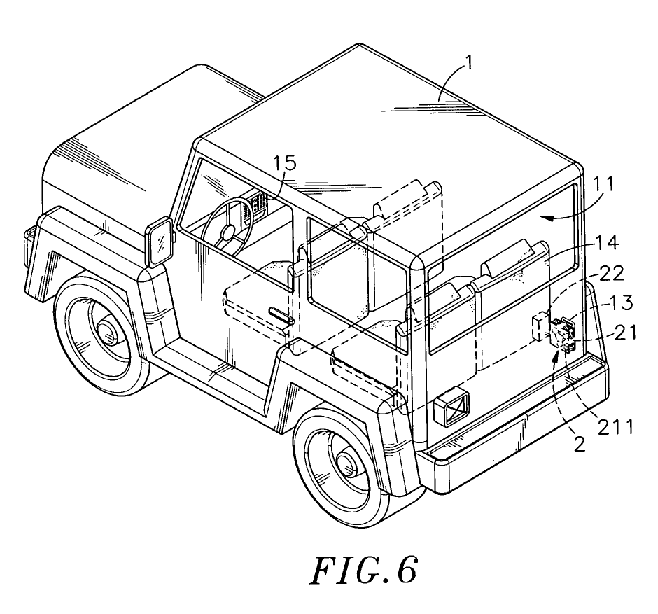

Referring to FIG. 6, the motor vehicle cooling system 2 can be used in a van, recreational & leisure vehicle or trunk that does not have a trunk 12. According to this embodiment, the motor vehicle cooling system 2 comprises at least one ventilation panel 13 installed in the rear side within the motor vehicle inside space 11 of the motor vehicle 1, at least one first electric fan 21 respectively mounted on the at least one ventilation panel 13 and adapted to suck air from the motor vehicle inside space 11 for expelling to the outside of the motor vehicle 1 through the at least one ventilation panel 13, and a storage battery 22 electrically connected to the at least one first electric fan 21 to provide the at least one first electric fan 21 with the necessary working voltage.

Referring to FIGS. 1 and 3˜6 again, the air cooling system 2 further comprises a first sensor switch 211 installed in each first electric fan 21 and adapted to detect the temperature in the trunk 12 around the associating first electric fan 21 and to turn on/off the associating first electric fan 21 subject to a pre-set temperature level, and a second sensor switch 241 installed in each second electric fan 24 and adapted to detect the temperature in the motor vehicle inside space 11 around the associating second electric fan 24 and to turn on/off the associating second electric fan 24 subject to a pre-set temperature level. According to the embodiment shown in FIG. 6, a first sensor switch 211 is installed in each first electric fan 21 and adapted to detect the temperature in the trunk 12 around the associating first electric fan 21 and to turn on/off the associating first electric fan 21 subject to a pre-set temperature level.

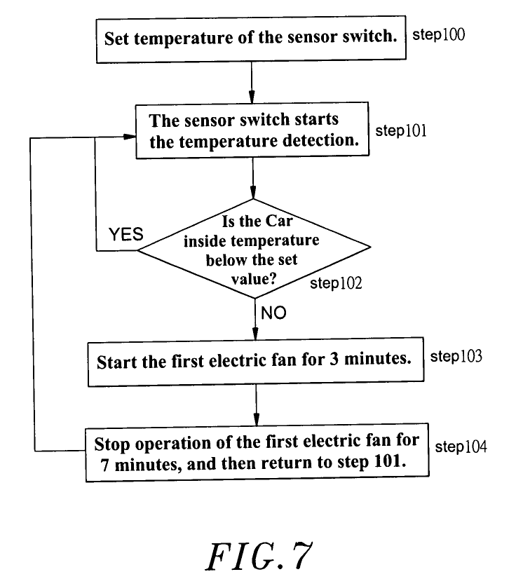

Referring to FIG. 7, the first electric fan 21 and the associating first sensor switch 211 are operated subject to the following steps:

(100) set the actuating temperature level of the first sensor switch 211;

(101) turn on the first sensor switch 211 to detect ambient temperature;

(102) judge whether or not the detected ambient temperature is below the set actuating temperature level? And then return to step (101) when the detected ambient temperature is below the set actuating temperature level, or proceed to step (103) when the detected ambient temperature is not below the set actuating temperature level;

(103) start the associating first electric fan 21 for three minutes; and

(104) stop the first electric fan 21 for seven minutes and then return to step (101).

If the actuating temperature level of the first sensor switch 211 is set at 45° C., the first sensor switch 211 immediately switches on the associating first electric fan 21 for three minutes when the ambient temperature reaches 45° C. When the three-minute operating time is up, the first sensor switch 211 switches off the associating first electric fan 21 for seven minutes, and then detects the ambient temperature again. If the detected ambient temperature is still above 45° C., the first sensor switch 211 immediately switches on the associating first electric fan 21 again for another three minutes and then switches off the associating first electric fan 21 for another seven minutes after the secondary three-minute operating time is up. Each second electric fan 24 and the associating second sensor switch 241 are operated in the same manner. By means of the control of the first sensor switch 211 and the second sensor switch 241, the first electric fan 21 and the second electric fan 24 are operated intermittently, saving much power consumption.

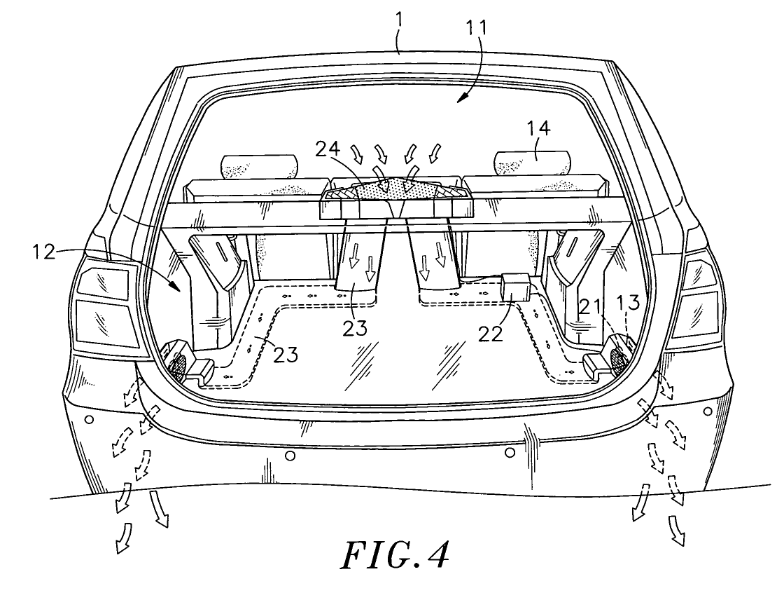

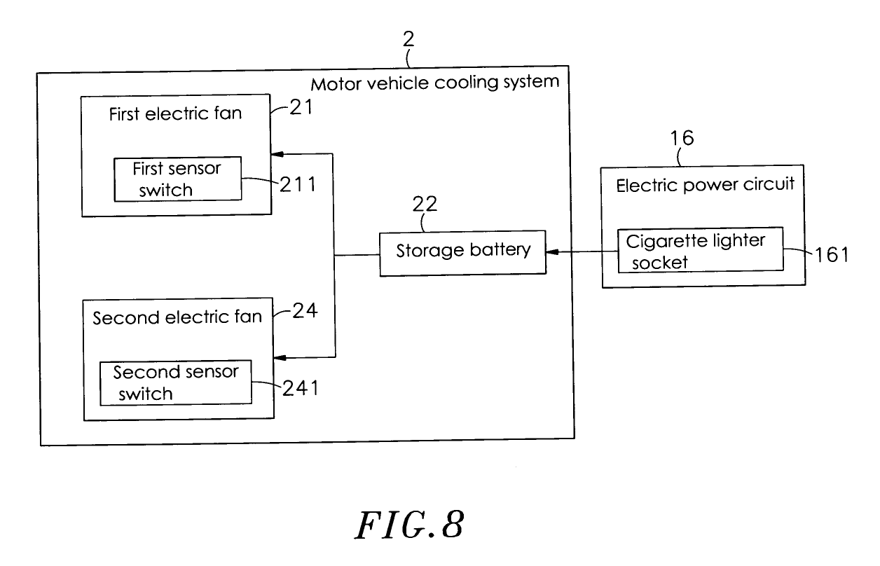

Referring to FIG. 8 and FIGS. 4˜6 again, the storage battery 22 can be installed in the motor vehicle inside space 11 behind the rear seat 14. Alternatively, the storage battery 22 can be installed in the trunk 12 of the motor vehicle 1. The installation location of the storage battery 22 will no interfere with utilization of the motor vehicle inside space 11 or the trunk 12 of the motor vehicle 1. Further, the storage battery 22 is electrically connected to the cigarette lighter socket 161 of the electric power circuit 16 of the motor vehicle 1. When the driver turn on the ignition switch of the motor vehicle 1, the electric power circuit 16 of the motor vehicle 1 provides an electric current to the motor vehicle engine of the motor vehicle 1 to start the motor vehicle engine, and at the same time a part of the electric power of the motor vehicle 1 is transmitted to the cigarette lighter socket 161 and then the storage battery 22 to charge the storage battery 22 for working.

Further, different types and models of motor vehicles 1 from different suppliers may have a different power circuit design, i.e., the cigarette lighter socket 161 of the electric power circuit 16 of a motor vehicle 1 may be designed to stop the supply of electric power or to keep supplying electric power when the motor vehicle engine is turned off. If the electric power circuit 16 of the motor vehicle 1 keeps supplying electric power to the cigarette lighter socket 161 when the motor vehicle engine is turned off, the storage battery 22 will consume the power supply of the motor vehicle battery of the motor vehicle 1. Therefore, a manual switch (not shown) is necessary for enabling the driver to switch off the cigarette lighter socket 161 after the motor vehicle engine has been turned off, preventing waste of motor vehicle battery power.

In general, the motor vehicle cooling method and system of the present invention has the following features and advantages:

1. The first electric fans 21 draw air out of the motor vehicle inside space 11 to the outside of the motor vehicle 1 through the ventilation panels 13 to cause negative pressure in the motor vehicle inside space 11, and the outer loop of the air conditioner of the motor vehicle 1 sucks outside cooling air into the motor vehicle inside space 11 through the air conditioner ventilation panels 15 for mixing with the air in the motor vehicle inside space 11 to lower the temperature of the motor vehicle inside space 11, and the circulation of air is continued to effectively lower the temperature of the motor vehicle inside space 11.

2. The storage battery 22 provides the first electric fans 21 and the at least one second electric fan 24 with the necessary working voltage. Because the storage battery 22 is not expensive, the air cooling system is cost-effective.

3. The storage battery 22 can be installed in the motor vehicle inside space 11 behind the rear seat 14 or in a corner area in the trunk 12 without interfering utilization of the motor vehicle inside space 11 or the storage space of the trunk 12.

4. The storage battery 22 can easily be installed in the motor vehicle inside space 11 behind the rear seat 14 or in a corner area in the trunk 12, and then electrically connected to the first electric fans 21 and the at least one second electric fan 24 with electric wires. The installation of the storage battery 22 is easy and not complicated.

5. The storage battery 22 can be electrically connected to the cigarette lighter socket 161 of the electric power circuit 16 of the motor vehicle 1. When the driver started the motor vehicle engine, a part of the motor vehicle battery power is transmitted to the cigarette lighter socket 161 to charge the storage battery 22 so that the storage battery 22 can work long.

6. Sensor switches 211 and 241 are respectively installed in the first electric fans 21 and the at least one second electric fan 24 to detect the ambient temperature. When the ambient temperature reaches a preset temperature level, the respective sensor switch 211 or 241 immediately switches on the associating electric fan 21 or 24 to operate for three minutes and than switches off the associating electric fan 21 or 24 for a period of seven minutes after a three-minute operation. This operation manner saves much power consumption.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. A motor vehicle air cooling method, comprising the step of using a motor vehicle cooling system in a motor vehicle to draw hot air out of said motor vehicle so as to cause negative pressure in said motor vehicle for sucking outside cooling air into the inside of said motor vehicle to have the pressure inside said motor vehicle be in balance with the pressure outside said motor vehicle and to simultaneously lower the temperature in said motor vehicle.

2. The motor vehicle air cooling method as claimed in claim 1, wherein said motor vehicle cooling system comprises at least one ventilation panel installed in a rear side of said motor vehicle and at least one electric fan (or any pipes that can blow actively) respectively installed in said at least one ventilation panel and adapted to draw air out of said motor vehicle through said at least one ventilation panel.

3. The motor vehicle air cooling method as claimed in claim 2, wherein said motor vehicle cooling system further comprises at least one sensor switch installed in said at least one electric fan and adapted to detect temperature around said at least one electric fan and to switch on said at least one electric fan when the detected temperature surpasses a predetermined value.

4. The motor vehicle air cooling method as claimed in claim 1, wherein said motor vehicle cooling system further comprises a storage battery electrically connected to a cigarette lighter socket of an electric power circuit of said motor vehicle for charging by said electric power circuit of said motor vehicle.

5. A motor vehicle air cooling system installed in a motor vehicle having an air conditioner ventilation panel set in an outer loop position for letting outside air to flow into the inside of said motor vehicle, the motor vehicle air cooling system comprising at least one ventilation panel installed in a rear side of said motor vehicle, at least one electric fan respectively installed in said at least one ventilation panel and adapted to draw air out of said motor vehicle through said at least one ventilation panel and to cause negative pressure in said motor vehicle, and at least one sensor switch installed in said at least one electric fan and adapted to detect temperature around said at least one electric fan and to switch on said at least one electric fan when the detected temperature surpasses a predetermined value.

6. The motor vehicle air cooling system as claimed in claim 5, further comprising a storage battery electrically connected to a cigarette lighter socket of an electric power circuit of said motor vehicle for charging by said electric power circuit of said motor vehicle.

7. A motor vehicle air cooling system installed in a motor vehicle, said motor vehicle comprising a motor vehicle inside space, a trunk at a rear side of said motor vehicle, a rear seat set in between said motor vehicle inside space and said trunk, and an air conditioner installed ventilation panel in said motor vehicle inside space and set in an outer loop position for letting outside air to flow into said motor vehicle inside space, the motor vehicle air cooling system comprising:
at least one ventilation panel installed in a rear side of said trunk;
at least one air duct mounted in said trunk and extending from said motor vehicle inside space to said at least one ventilation panel for guiding air out of said motor vehicle inside space to the outside of said motor vehicle through said at least one ventilation panel;
at least one electric fan respectively installed in said at least one ventilation panel and adapted to draw air out of said motor vehicle inside space through said at least one air duct and said at least one ventilation panel; and
at least one sensor switch respectively installed in said at least one electric fan and adapted to detect temperature around said at least one electric fan and to switch on said at least one electric fan when the detected temperature surpasses a predetermined value.

8. The motor vehicle air cooling system as claimed in claim 7, further comprising a storage battery installed in said trunk and electrically connected between a cigarette lighter socket of an electric power circuit of said motor vehicle and said at least one electric fan for charging by said electric power circuit of said motor vehicle and for providing the necessary working voltage to said at least one electric fan.

9. The motor vehicle air cooling system as claimed in claim 7, further comprising at least one second electric fan installed in said motor vehicle inside space and adapted to draw air out of said motor vehicle inside space into said at least one air duct, and at least one second sensor switch respectively installed in said at least one second electric fan and adapted to detect temperature around said at least one second electric fan and to switch on said at least one second electric fan when the detected temperature surpasses a predetermined value.

10. The motor vehicle air cooling system as claimed in claim 7, wherein said at least one air duct each is comprised of a plurality of flexible tubes connected in series.

11. The motor vehicle air cooling system as claimed in claim 7, wherein said at least one air duct each is comprised of a plurality of at least one flat tube.
